(19) United States
(12) Patent Application Publication
(10) Pub. No.: US 2007/0221077 A1
(43) Pub. Date: Sep. 27, 2007

(54) Method and Control Unit for a Label Printer

(76) Inventor: Johannes Lenkl, Freising (DE)

Correspondence Address: Jonathan A Platt;Renner Otto Boisselle & Sklar, 1621 Euclid Avenue, 19th Floor, Cleveland, OH, 44115, US

(21) Appl. No.: 11/587,193

(22) PCT Filed: Apr. 19, 2005
(86) PCT No.: PCT/EP05/04178

§ 371 Date: Oct. 20, 2006

(30) Foreign Application Priority Data
Apr. 20, 2004 (DE) 10 2004 019 074.7

(51) Int. Cl. B41F 1/08

(52) U.S. Cl. 101/288

(57) ABSTRACT

The invention concerns a method of controlling a label printer, in particular a thermotransfer printer, for printing labels (50) having an RFID portion (52), comprising the following steps: feeding a label (50), placing a printing head (22) of the label printer on the label (50) which is passing into the operative region thereof and which is to be printed upon, printing on the label with a selected print image, and lifting the printing head (22) off the label (50). The printing head (22) is lifted off or not placed on the label (50) in dependence on a first programmable parameter which contains a first item of information about the relative position of the RFID portion (52) on the label (50) to be printed. The invention further concerns a correspondingly adapted label printer.

The invention concerns a method of controlling a label printer, in particular a thermotransfer printer, for printing labels having an RFID (radio frequency identification) portion comprising the steps: feeding labels arranged in succession on a label carrier strip, placing a printing head of the label printer on a label which is passing into the operative region thereof and which is to be printed upon, printing on the label with a selected print image and lifting the printing head off the label. The invention further concerns a label printer for printing such labels having a control unit set up with program technology, for carrying out such a method.

Labels of the kind set forth above are known and are widely used in practice. In accordance with the invention the expression labels with an RFID portion (hereinafter referred to as RFID labels for the sake of brevity) is used to denote labels which can store information which can preferably be electronically read-out in contact-free mode. The information is typically read out by means of electromagnetic waves in the radio or microwave range of different frequency bands such as the HF band (between 6 MHz and 30 MHz), the UHF band (between 30 MHz and 300 MHz) or the UHF band (between 300 MHz and 3 GHz). There are a large number of known storage means, also referred to as transponders, which can be used for storing information for use in RFID labels. The purpose thereof is to re-radiate or return an electromagnetically introduced signal with the information encoded in some manner (response signal). It is possible for that purpose to use for example integrated electronic components (chips) with small antennae down to—in the simplest case—coils of a given size and with a given number of turns, that is to say both passive and also active RFID components. While some retain the information in a non-modifiable fashion, others are temporarily or permanently writable. Depending on the frequency band and in particular the nature of the storage medium and the connected electronics on the chip, it is possible to achieve different ranges for the RFID response signal.

So that such electronically readable RFID labels can also be read out optically, for example by a person or a bar code scanner, they are printed upon by a label printer in known manner. Preferably so-called thermotransfer printers are used for that purpose because of the low mechanical loading on the labels and at the same time the long service life of the print. In thermotransfer printing an ink (preferably black) or a plurality of inks are applied from a thermotransfer ink ribbon to the label surface by means of a heatable printing head by being fused thereon, in accordance with printer actuation. During the printing operation the thermotransfer ink ribbon is drawn through below the printing head, whereby the desired print image is produced.

Such RFID labels are applied for example to goods, packaging boxes or pallets and are there used as goods information carriers or transport information carriers. It is possible for the most widely varying kinds of information to be stored on such labels, such as for example the name and address of the recipient or the customer for whom the article is intended, product information or the like. That information can be easily read out for example by a carrier or an inventory whereby for example the whereabouts, the transport route of the article or the like can be tracked at any time. The reading-out operation can take place fully automatically by an RFID reading unit being installed for example in the goods entry area, so that therewith the arrival of the article and other information about that article can be registered or read out upon delivery while the label is passing.

The storage means introduced into such a label generally involve very small dimensions in the millimetre range. Therefore they can be disposed in flat plastic material or paper strips. However those electronic storage means and in particular the electronic contacts and antennae are relatively delicate and can be damaged when the label is bent or due to pressure applied locally to the label. Great care has to be used therefore particularly when printing on the labels.

The object of the invention is accordingly to provide a method and a label printer for printing on labels having an RFID portion, which minimises the risk of damage to the electronic storage means in the RFID label.

According to the invention that object is attained by a method and a label printer of the kind set forth in the opening part of this specification, having the characterising features of claim 1 and claim 16 respectively. Claims 2 to 15 relate to advantageous configurations and developments of that invention.

The position of the RFID portion on the label is not always the same. That fact is taken into account by the provision of a first programmable parameter which contains a first item of information about the relative position of the RFID portion on the label to be printed. The term “programmable parameter” in accordance with the invention is used to denote any value which is to be inputted prior to the start of the program or execution of the method, for procedural control in respect thereof. Programmable is used synonymously with inputtable or selectable. Depending on the design of the label which is just to be printed, in that way the position of the RFID portion can be deduced from the parameter, for example in relation to the beginning of the label, and thus the printing head can be lifted off the label in the region of the RFID portion so that the printing head does not apply any pressure to the label in that RFID portion. In the case of an RFID portion arranged at the beginning of label, the printing head would initially not first be applied to the label at all, in dependence on the corresponding parameter. That no only avoids damage to the storage unit in the RFID portion but at the same time the printing head itself is protected from damage, whereby the service life of the printing head can be considerably prolonged.

It is only after the RFID portion has passed the printing head that it can be applied to the label again in order to continue the printing operation in a printable portion. That is preferably effected after a predetermined stroke duration from being lifted off or not placed on the label, which is determined by the first programmable parameter. In contrast to the programmable parameter, the term “predetermined stroke duration” means a fixedly programmed value which cannot be individually inputted prior to the start or the implementation of the method and which therefore cannot be altered from one program start to another. The method using a predetermined stroke duration presents itself when typically storage means of the same dimension and thus an RFID portion of the same length are always used.

In another preferred embodiment the operation of applying the printing head after the RFID portion has passed is controlled by means of a second programmable parameter. That parameter contains a second item of information about the relative position of the RFID portion on the label to the printed. The second item of information can be for example the spacing of the end of the RFID portion from the beginning of the label in relation to the feed direction or the spacing of the end of the RFID portion in relation to the beginning of the RFID portion.

It is advantageous for the feed of the label to be monitored by a sensor. Preferably an optical sensor is used for that purpose. It is however also basically possible to use for that purpose a mechanical, acoustic, electrical or electromagnetic sensor. In particular an RFID (writing and) reading unit can be used for that purpose.

The sensor preferably outputs a signal, on the basis of which the entry of the beginning of the label into the operative region of the printing head is ascertained. From that entry on, a spacing is maintained which is proportional to the first parameter, before the printing head is lifted off the label. That embodiment of the method enjoys the advantage that, for example in the case of a plurality of labels which are fed arranged in succession on a label carrier strip, damage-free printing on the labels is guaranteed even when the labels are not always at the same spacings relative to each other.

In a particularly preferred feature the printing head is lifted off the label to be printed upon at the beginning of an empty region of the selected print image, insofar as it has not already been lifted off in dependence on the first parameter and has not been placed on the label again in dependence on the predetermined duration or the second parameter, and at the end of the empty region of the selected print image it is placed on the label again insofar as it dos not have to be lifted off in dependence on the first parameter and on the predetermined duration or the second parameter.

It is advantageously possible in that fashion to save on thermotransfer ink ribbon if the printer is a thermotransfer printer with a transport device for the thermotransfer ink ribbon which is stopped at the beginning of the empty region of the selected print image and is started again at the end of the empty region of the selected print image (film saving mode).

It is also advantageous when using a thermotransfer printer for the transport device for the thermotransfer ink ribbon to be stopped in dependence on the first parameter and to be started again in dependence on the predetermined duration or the second parameter. It is also particularly advantageous, in terms of minimum consumption of thermotransfer ink ribbon, for stopping and re-starting of the transport device for the thermotransfer ink ribbon of both the above-indicated advantageous embodiments to be combined in such a way that it takes place in each case with the printing head being lifted off the label to be printed upon and with the printing head being placed on the label to be printed upon respectively.

Particularly when a very high printing speed is involved however it may be advantage for the transport device for the thermotransfer ink ribbon also to be stopped only when a holding time ascertained by calculation on the basis of the feed speed of the labels and the length of the empty region does not fall below a predetermined minimum value. The holding time cannot be shortened just as may be desired as, particularly when dealing with a very high printing speed with which the transport speed of the transfer ribbon must be synchronised, high levels of acceleration and, on the basis of the not inconsiderable mass of the thermotransfer ink ribbon which is wound onto a supply roll, high forces are also required in the starting and deceleration phases. The predetermined minimum value is accordingly a fixedly programmed value which is matched to the label printer and which takes account of the time required for acceleration and deceleration of the thermotransfer ink ribbon and the transport device for driving same.

The method according to the invention and the label printer according to the invention can be used both for printing on labels with an RFID portion, which are introduced individually, and also for such labels which are arranged in succession on a label carrier strip.

The labels on a label carrier strip can be arranged in such a way as to maintain equal or unequal spacings or in immediately mutually adjoining relationship. Such labels are usually held on the label carrier strip by means of an adhesive layer which is at least partially applied at their side which faces towards the label carrier strip, in which case the label carrier strip is provided on its side facing towards the label with a coating which on the one hand permits the label to adhere to the adhesive layer and which on the other hand permits detachment of the label without destroying the adhesive layer. After the printing operation and encoding of the storage means by means of a reading and/or writing unit the labels are typically discharged over a dispensing edge and applied to the product, packaging or the like which is to be labelled.

Further objects, features and advantages of the invention are described in greater detail hereinafter by means of embodiments by way of example with reference to the Figures in which:

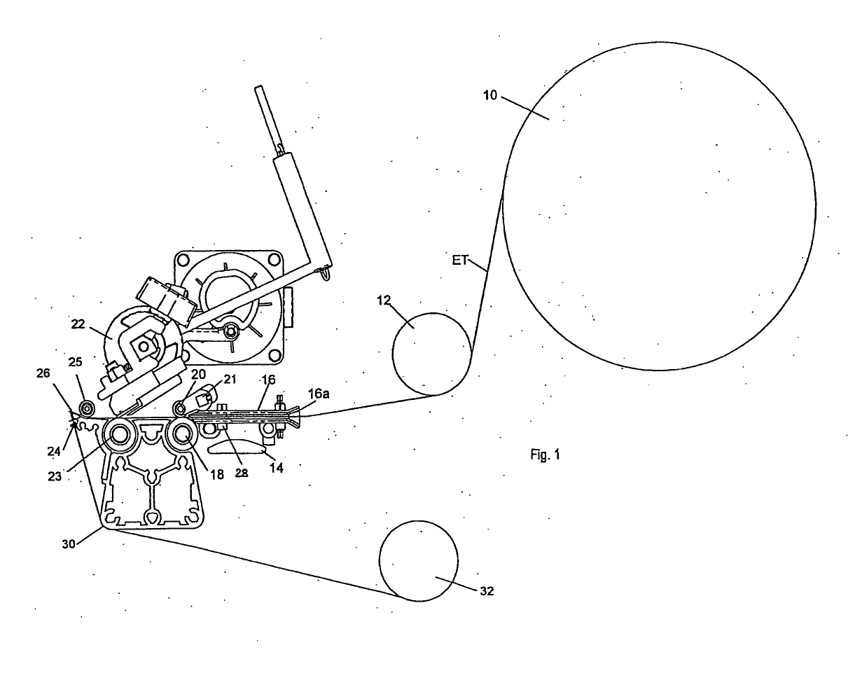

FIG. 1 shows a diagrammatic side view of the label printer according to the invention with a printing head applied to a label to printed,

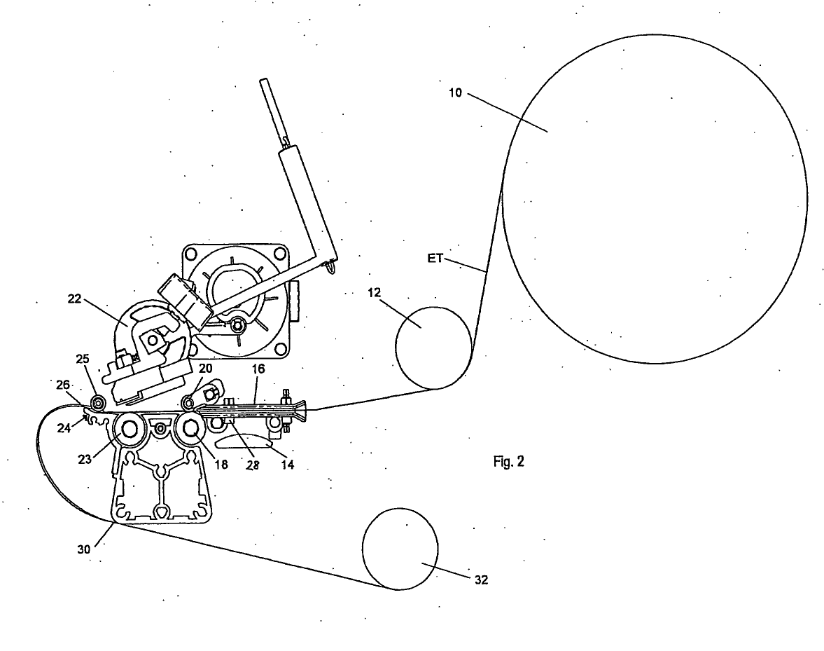

FIG. 2 shows a further diagrammatic side view of the label printer according to the invention as shown in FIG. 1 with the printing head in a position of being lifted off the label to be printed upon,

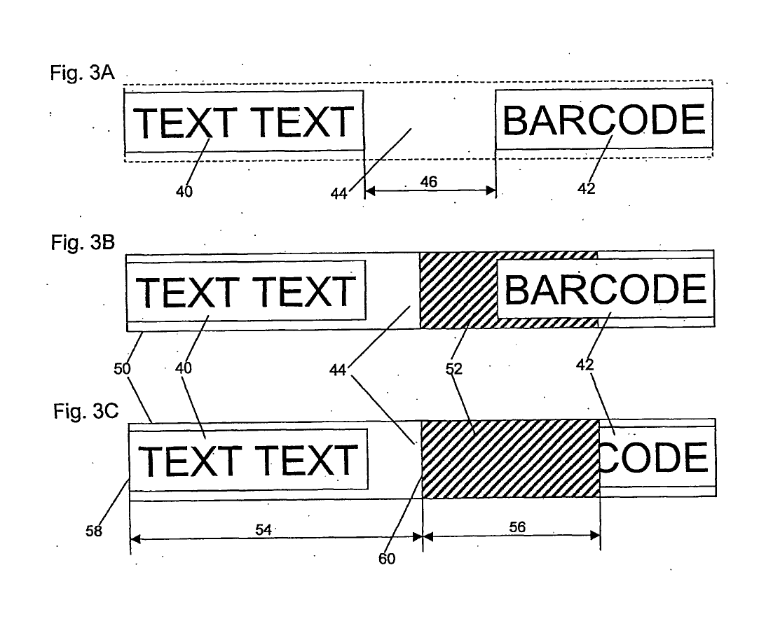

FIG. 3A shows a print image by way of example,

FIG. 3B shows a diagrammatic view of an RFID label printed with the print image of FIG. 3A by means of a known label printer, and

FIG. 3C shows a diagrammatic view of an RFID label printed with the print image of FIG. 3A by means of a label printer according to the invention.

FIGS. 1 and 2 are diagrammatic side views of a label printer according to the invention which is suitable for carrying out the method according to the invention. For the sake of clarity of the drawing a casing which generally surrounds the label printer is not shown.

The label printer according to the invention has as essential components a supply roll 10 which is formed by the label carrier strip ET wound thereon and whose axis (not shown) extends at least approximately horizontally. Disposed at regular spacings on the label carrier strip ET are labels (not shown) having an RFID portion and a printable portion or print carrier portion. Both the RFID portion and also the print carrier portion are not shown in greater detail here.

The label carrier strip ET provided with the labels is drawn off the supply roll 10, guided substantially vertically downwardly and passed around a direction-changing roll 12 whose axis is also oriented at least approximately horizontally. The direction-changing roll 12 approximately horizontally orients the label carrier strip ET which is fed at least approximately vertically thereonto. It is generally mounted at the end of an arm (dancer arm, not shown) which is pivotable about the axis of the supply roll 10 and which is resiliently prestressed and it thus serves at the same time for tensioning the label carrier strip in the event of tension thereof decreasing. Provided downstream of the direction-changing roll 12 in the conveyor direction of the label carrier strip ET is an RFID reading and/or writing unit 14. The RFID reading and/or writing unit 14 is formed by an antenna which is disposed below the label carrier strip ET which extends horizontally in that region. That RFID reading and/or writing unit 14 can at the same time form a testing unit which checks the RFID portion of a label disposed on the label carrier strip ET for defects. Basically there is the possibility in that respect of the RFID portion of the label already being provided with items of information which do not have to be supplemented by any further items of information. In such a case the RFID reading and/or writing unit 14 is only a reading unit. If in contrast items of information are to be applied to the RFID portion of the label then the RFID reading and/or writing unit is an RFID reading and writing unit.

In addition, provided in the region of the RFID reading and writing unit is a light barrier arrangement 28 as an optical sensor which registers the passage of a label or more precisely the beginning of a label and signals that event to the control unit (not shown) (print control). It is on the basis of that signal and the known transport speed that the entry of the beginning of the label into the operative region of a printing head 22 arranged at a downstream position can be ascertained. Unlike the case shown in FIGS. 1 and 2, the light barrier arrangement can also be arranged horizontally and/or at another location along the label carrier strip, for example closer to the printing head.

Alternatively the signal received by means of the RFID reading and/or writing unit 14 when an RFID label passes can be used as a sensor signal for monitoring the label feed or, in other words, the RFID reading and/or writing unit 14 can be used at the same time as a sensor for controlling the label printer. In that case that signal is fed to the printer control (not shown).

The printer control can be implemented by means of specifically adapted electronic components and/or computers in conjunction with a control program.

So that the label to be checked which is arranged on the label carrier strip ET occupies a precisely defined position in relation to the RFID reading and/or writing unit 14, provided in the region of the RFID reading and/or writing unit 14 is a tunnel guide 16 formed by two plate-shaped elements extending at least approximately parallel to the path of conveying movement of the label carrier strip ET. In order to permit the label carrier strip ET to be easily threaded into the tunnel guide 16, it has an introduction funnel configuration 16a at its end which faces towards the supply roll 10.

Arranged downstream of the tunnel guide 16 in the conveyor direction of the label carrier strip ET is a first drive roller 18 which is disposed beneath the label carrier strip ET, and a counterpressure roller 20 provided above the label carrier strip ET.

Both the axis of the drive roller 18 and also that of the counterpressure roller 20 again extend horizontally. The two rollers 18, 20 receive the label carrier strip ET between them, as is shown in FIGS. 1 and 2, and can convey the label carrier strip ET by the drive of the drive roller 18. In that case the counterpressure roller 20 provides for adequate contact between the drive roller 18 and the label carrier strip ET so that the conveyor operation can be carried out.

The counterpressure roller 20 is mounted to a holding arm 21 which is reversibly pivotable upwardly and downwardly in a vertical plane so that the counterpressure roller 20 can compensate for unevenness and irregularities on the label carrier strip ET, as are caused for example by the RFID portion of the label, without reducing the contact force of the roller 20 and in that case damage to the RFID portion is prevented. In an alternative embodiment, in addition instead of a counterpressure roller 20 it is possible for a pair of rollers (or possibly further rollers) to be arranged displaceably transversely with respect to the label carrier strip ET on the same axis. Depending on the respective position of the RFID portion on the label or on the carrier strip ET, the counterpressure rollers can be adjusted in such a way that the RFID portion does not come into contact with any thereof, but passes through a gap between two of the rollers.

As a further alternative to the light barrier arrangement 28 the holding arm 21 or the counterpressure roller 20 can be provided with a printer sensor or with a simple switch with which the passage of a raised RFID portion on a label or of the label which is raised with respect to the label carrier strip can be detected. In that case the holding arm 21 or the counterpressure roller 20 would be used as a sensor for controlling the label printer. The signal produced in that way can also be provided as a control signal for monitoring the label feed in accordance with the invention. The first drive roller 18 can be made from steel with a suitable rubber casing. There is also the possibility of the first drive roller 18 being formed from a GRP material with or without a corresponding rubber casing.

Disposed downstream of the drive roller 18 in the conveyor direction of the label carrier strip ET adjoining the first drive roller 18 is a printing head 22 arranged above the label carrier strip ET. The printing head 22 is a thermotransfer printing head which can apply printing to the printable portion or portions of the label by a thermotransfer printing step in known manner. Arranged below the printing head 22 is a platen roller 23 which can also be formed from a steel core with a rubber casing or a GRP core with and without a rubber casing.

The printing head 22 can assume the writing position shown in FIG. 1. In addition however as shown in FIG. 2 it can be lifted off the label carrier strip ET or the label in the RFID portion or in an empty region of the print image, by being pivoted upwardly. The former provides that both the printing head 22 and also the RFID portion or the delicate electronic components disposed therein on the label such as the memory unit, antenna, contacts and connections, are protected from damage when the RFID portion passes through the operative region of the printing head.

Disposed downstream of the printing head 22 in the conveyor direction of the label carrier strip ET is a dispensing unit 24 which is arranged above the label carrier strip ET and has a guide roller 25 and dispensing edge 26. The guide roller 25 whose axis extends at least approximately horizontally is arranged downstream of the printing head 22 or the roller 23 in the conveyor direction of the label carrier strip ET, while the dispensing edge 26 directly adjoins the guide roller 25 at a downstream position in the conveyor direction of the label carrier strip ET.

As a consequence of the sharp change in direction of the label carrier strip ET at the dispensing edge 26 a label which is to be applied or dispensed is lifted off the label carrier strip ET and can then be applied to the article to be labelled by hand or by means of an applicator unit (not shown in greater detail). The label carrier strip ET from which the label has been removed, that is to say the empty label carrier strip ET, is passed to a further direction-changing edge 30 and from there onto a take-up roll 32 which serves as an empty strip storage unit.

The method according to the invention and the mode of operation of the label printer according to the invention are as follows:

A portion of the label carrier strip ET, which has been drawn off the supply roll 10 and to which a label to be written to is applied is firstly passed after a change in direction around the direction-changing roll 12 to the testing unit or the RFID reading and/or writing unit 14. There a check is made to ascertain whether the RFID portion of the label is intact. If that is the case then the label is fed to the printing head 22 and the desired information is printed thereon. Information can possibly also be previously read from the RFID portion of the label and/or written into the RFID portion of the label in the RFID writing and/or reading unit. Prior to the operation of printing on the label the control unit is supplied with the signal—produced with whatever kind of sensor—on the basis of which either the entry of the beginning of the label or the RFID portion into the operative region of the printing head 22 is ascertained on the basis of the transport speed of the label carrier strip and the distance between the sensor and the operative region.

It is on that basis and by means of the programmable parameter that the control unit can ascertain by calculation both the beginning of the label and also the beginning of the RFID portion. The result is passed as a control signal to a drive for lifting the printing head off the label or placing it on the label, thereby firstly ensuring that the printing head is placed on the label only in the printable portion disposed upstream of the RFID portion (if present; that corresponds to the distance between the beginning of the label and the RFID portion).

In addition, by means either of the predetermined stroke duration or the second programmable parameter, the moment in time is calculated at which the printing head is placed on the label again after the RFID portion is passed. The calculation can be based either on the given calculated beginning of the label or the given calculated beginning of the RFID region, depending on to which respective one of those two beginnings the second parameter is related, and add a value proportional to the second parameter. That result is also passed as a control signal to the drive for the printing head 22.

The control signal for the drive of the printing head 22 can additionally be dependent on the print image if for example a film saving mode is fixedly implemented in the program execution of the control unit, that is to say permanently in a predetermined manner, or whether it is provided in such a way that it can be switched on for example by. setting a flag or actuating a switch.

In that case the printing head 22 is applied to the label only when both the parameter control indicates that an RFID portion is not passing and also the (switched-on) film saving mode indicate a non-empty region of the print image (that is to say a printing command). Otherwise, the drive for the printing head would receive no control signal for being placed on the label or a control signal for being lifted off, for one reason or another.

Finally, the output of a control signal for lifting off the printing head can be linked to a control signal for stopping the transport device (not shown in detail) for the thermotransfer ink ribbon (also not shown) so that further transport of the thermotransfer ink ribbon is stopped always or under additional conditions when the printing head is lifted off the label and is started again when the printing head is re-applied.

Then the label carrier strip ET is fed together with the label to the dispensing unit 24. Due to the sharp change in direction of the label carrier strip ET at the dispensing edge 26 the label which has been printed upon and/or written to in the RFID portion is pulled off the label carrier strip ET and can then be engaged by hand or by the applicator unit (not shown) and applied to the article to be identified by the label. The label carrier strip ET from which the label has been removed experiences a change in direction at the dispensing edge 26 and is guided at the direction-changing device 30 to the take-up roll 32 for the empty label strip ET and is wound thereon.

The embodiment illustrated in FIGS. 1 and 2 is a combined RFID reading/writing unit with label printer, which is provided for the above-described dispenser mode of operation. In the dispenser mode of operation, that is to say in a forward movement of the label carrier strip, the drive for the label carrier strip is effected by way of the take-up roll 32 and possible the drive roller 18. The drive for the platen roller 23 is uncoupled at least when the printing head 22 is lifted off. The platen roller 23 then runs idly therewith. The platen roller 23 can possibly also be driven when the printing head is applied (printer mode of operation). In the case of the reverse movement of the label carrier strip ET, which is in opposite relationship to the printer or dispenser mode and which may be required for example for precise positioning of the RFID portion under the antenna of the reading and/or writing unit 14, the drive roller 18 and possibly also the platen roller 23 are responsible for the drive. In the reverse movement it can advantageously be provided that the control causes the printing head to be lifted off. That is advantageous in particular having regard to the beginning of the RFID portion, which is ascertained in accordance with the method of the invention, as it is precisely in the reverse movement that the risk of damage to the RFID portion and the printing head 22 is very great. The printing head 22 can either be lifted off generally in a feed direction which in opposite relationship to the feed direction in the normal printer or dispenser mode (reverse movement of the label carrier strip ET). The control system can alternatively be so programmed that the printing head 22 is also lifted off in the reverse movement only in dependence on the predetermined stroke duration or the second parameter and is placed on the label in dependence on the first parameter, on condition that the spacings which are proportional to the parameter and the stroke duration respectively are maintained so that the RFID portion disposed in the operative region of the printing head is not damaged.

The invention is not limited to such RFID reading/writing units. It is also used in other label printers, in particular those which are not intended for the dispenser mode of operation. That eliminates the dispensing unit 24 with dispensing edge 26 and the take-up roll 32. The labels are separated from each other for example by a blade connected downstream of the printing head 22 or are torn away (manually) along a perforation provided transversely on the label carrier strip ET. In such an apparatus, the drive in the forward movement and also the reverse movement is typically effected both by way of the platen roller 23 and also the drive roller 18. In this case also it can be provided in the reverse movement that the control system causes the printing head to be lifted off.

Reference is now made to FIGS. 3A to 3C showing a print image by way of example and also an RFID label with that print image printed thereon, which in the case of FIG. 3B was printed upon by a previously known label printer and in the case of FIG. 3C by a label printer according to the invention.

The print image shown in FIG. 3A has a first printed region 40 with a readable text, a second printed region 42 with a machine-readable bar code and an empty region 44 of a width identified by an arrow 46.

When that print image is applied to an RFID label 50 as is shown in FIGS. 3B and 3C with an RFID portion 52, the result depends on whether a label printer as is known from the state of the art was used, see FIG. 3B, or whether the print image was applied with a label printer according to the invention, see FIG. 3C. In the case of the known label printer the printing head always bears against the label when the printer receives a print command, that is to say when there is printed region. Accordingly the printing head even bears against the label in the region of the RFID portion 52 and can damage the electronic elements, connections, antennae etc. which are to be found there, by virtue of the contact pressure involved. Irrespective of that, the printing head can be lifted off in the empty region 44 in dependence on a film saving mode which can be switched on if the width 46 of the empty region 44 is not too small and rules out the printing head being lifted off because the duration for stopping the thermotransfer ink ribbon and for subsequently re-starting it again, in dependence on the label transport speed, is not sufficient.

In comparison, the RFID region 52 is not printed upon with the label printer according to the invention as in that region the printing head is always lifted off the label, see FIG. 3C. This therefore basically avoids damage to the memory unit or other electronic components in the RFID region. The consequence of this is that the print image involved is not completely reproduced on the label. Consequently the operator must select a different layout for such a label. In other words, the label printer according to the invention protects the RFID portion even when the print image provides for writing to that portion as a result of defective programming.

The procedure involved in lifting off the printing head and re-applying it to the label before and after the RFID portion respectively is made possible by a suitable choice in respect of the first parameter which represents the length, identified by the arrow 54, of the label portion from the beginning 58 of the label 50 to the beginning 60 of the RFID portion 52, and the second parameter representing the length, identified by the arrow 56, of the RFID portion 52.

1. A method of controlling a label printer, in particular a thermotransfer printer, for printing labels having an RFID portion, comprising the following steps:
feeding a label,
placing a printing head of the label printer on the label which is passing into the operative region thereof and which is to be printed upon,
printing on the label with a selected print image, and
lifting the printing head off the label,
characterised in that the printing head is lifted off or not placed on the label in dependence on a first programmable parameter which contains a first item of information about the relative position of the RFID portion on the label to be printed.

2. A method according to claim 1 characterised in that the printing head is placed on the label after a predetermined stroke duration from being lifted off or not placed on the label.

3. A method according to claim 1 characterised in that the printing head is placed on the label in dependence on a second programmable parameter which contains a second item of information about the relative position of the RFID portion on the label to be printed upon.

4. A method according to claim 1 characterised in that the feed of the label is monitored by a sensor.

5. A method according to claim 4 characterised in that the sensor outputs a signal, on the basis of which the entry of the beginning of the label into the operative region of the printing head is ascertained, from which a spacing proportional to the first parameter is maintained, before the printing head is lifted off the label.

6. A method according to claim 4 characterised in that the sensor outputs a signal, on the basis of which the entry of the RFID portion into the operative region of the printing head is ascertained, until which entry of the RFID portion a spacing proportional to the first parameter is maintained, before the printing head is lifted off.

7. A method according to claim 5 characterised in that from the entry of the beginning of the label into the operative region of the printing head on, a spacing proportional to the second parameter is maintained, before the printing head is placed on the label.

8. A method according to claim 5 characterised in that from the lift-off of the printing head on or from the entry of the RFID portion on, a spacing proportional to the second parameter is maintained, before the printing head is placed on the label.

9. A method according to claim 4 characterised in that the sensor is an optical sensor.

10. A method according to claim 1 characterised in that the printing head is lifted off the label to be printed upon at the beginning of an empty region of the selected print image, insofar as it has not already been lifted off in dependence on the first parameter and has not been placed on the label again in dependence on the predetermined stroke duration or the second parameter, and at the end of the empty region of the selected print image it is placed on the label again insofar as it does not have to be lifted off in dependence on the first parameter and on the predetermined stroke duration or the second parameter.

11. A method according to claim 1 characterised in that the printer is a thermotransfer printer with a transport device for a thermotransfer ink ribbon which is stopped in dependence on the first parameter and started again in dependence on the predetermined stroke duration or the second parameter.

12. A method according to claim 10 characterised in that the printer is a thermotransfer printer with a transport device for a thermotransfer ink ribbon which is stopped at the beginning of the empty region of the selected print image and is started again at the end of the empty region of the selected print image.

13. A method according to claim 10 characterised in that the printer is a thermotransfer printer with a transport device for a thermotransfer ink ribbon which is stopped with the lift-off of the printing head from the label to be printed upon and is started again with the printing head being placed on the label to be printed upon.

14. A method according to claim 11 characterised in that the transport device for the thermotransfer ink ribbon is also stopped only when a holding time ascertained on the basis of the feed speed of the labels and the length of the empty region does not fall below a predetermined value.

15. A method according to claim 1 characterised in that a plurality of labels are fed arranged in succession on a label carrier strip (ET).

16. A method according to claim 1 characterised in that the printing head is lifted off in the case of a feed direction in opposite relationship to the feed direction in the normal printing mode.

17. A method according to claim 16 characterised in that the printing head is lifted off in the case of a feed direction in opposite relationship to the feed direction in the normal printing mode in dependence on the predetermined stroke duration or the second parameter and is placed on the label in dependence on the first parameter.

18. A label printer, in particular a thermotransfer printer, for printing labels having an RFID portion, comprising a control unit set up with program technology, for carrying out the method according to claim 1.
